(19) United States
(12) Patent Application Publication
(10) Pub. No.: US 2020/0073129 A1
(43) Pub. Date: Mar. 5, 2020

(54) M-Piece Headset Communication Enhancement System

(71) Applicants: Maurice S. Byrd, Johns Creek, GA (US); Roman Gary, (US); Darryl Cunningham, SR., (US)

(72) Inventors: Maurice S. Byrd, Johns Creek, GA (US); Roman Gary, (US); Darryl Cunningham, SR., (US)

(21) Appl. No.: 16/118,984

(22) Filed: Aug. 31, 2018

(51) Int. Cl. G02B 27/01; G06F 3/01; H04R 5/033; H04R 5/04

(52) U.S. Cl. CPC G02B 27/0176; G02B 27/0172; G06F 3/014; G02B 2027/0138; H04R 5/04; G02B 2027/0169; H04R 5/0335

(57) ABSTRACT

The M-Piece is a headphone communication device that provides the methodology and system for enhancing the functionality of a “commercially developed” headset communication system. The enhancements include an encased detachable LED/LCD flat screen monitor; the monitor provides a display screen with imaging capabilities; a microphone for audio communications between multiple headsets, and other devices; a camera for photographic images; camcorder video recording; Wi-fi and/or wireless accessibility; and detachable wrist band for viewing photographs and other images. The M-Piece headset communication system is designed to provide the communicating party with privacy communication protections as the flat screen monitor may be utilized for blocking and shielding the speakers' mouth/lips while speaking. The communication system's camera and camcorder functionality allow the communicating party with the ability to take still photographs, as well as, video recordings.

### BACKGROUND ON THE INVENTION

### Field of the Invention

Generally, the M-Piece headset communication system invention relates to an encased LED/LCD flat screen monitor with audio headset communication between multiple headset communication devices; digital text or image display; Wi-Fi accessibility; a camera for taking still photographs and a camcorder for recording videos; and a detachable wristband with a monitor for viewing photographs, videos, and other transmitted images from the communication system.

### Description of Related Art

There are numerous events and activities where individuals and groups of individuals utilize commercially manufactured headsets for audio communications. During these activities/events, the headsets have microphones for communicating between multiple headsets. On each headset, the microphone is embedded in a mouthpiece bar attached to the headset. The headsets, typically, have mini speakers for each ear where audio communications may be heard. This form of audio usability provides the communicating party with the ability to communicate, not only to headsets, but to other devices such as gadgets, computers, smartphones, and tablets. Headsets may be utilized, not only for audio communications but for use with devices for listening to music and sounds on apps, music video streams, podcasts; etc.

Commercially manufactured headset systems are utilized for communications between two or more parties (a) at sporting events such as football games, motor sports contests, soccer games, and other indoor/outdoor sports; (b) catastrophic and medical emergency events involving first responders and medical professionals; etc.; and (c) logistical implementation activities manufacturing, warehousing, transportation, bulk product transfers, concerts, entertainment; etc.;

Multi-way communications between individuals and groups of individuals require multiple headsets with accessibility through wireless or Wi-Fi technology. There are numerous advantages to multiple headset communications depending on the location of the parties, event or activity. To fully take advantage of the convenience of headset communications, there are three critical requirements for successful usability. There must exist, for audio communications (a) a minimum level of noise interference; (b) continual and/or uninterrupted wireless technology access; and (c) privacy protections. Adherence to these requirements will ensure effective communications. If these requirements are not met, the intent and effectiveness of the audio communications may be seriously impacted.

An example of an event involving headset or headset system communications are sporting events such as a football game. In the National Football League, NCAA and NAIA, as well as, many high school football games, coaches utilize headsets to communicate to other coaches from the sidelines to an elevated level such as the press box or from the sidelines to the players on the field. The use of headsets to communicate to multiple coaches may be offensive and defensive play-by-play or situation strategies. On most levels of football programs, headset system communications have become an absolute must for coaches and their teams for communications during a game.

In a “game-time environment”, all the requirements for effective audio communications on a headset must exist. Noise may be a distraction or interfere with effective communications between the coaches and players. Crowd noise is the biggest source of communication distraction and interruption on a headset, however, there are instances that static noise from the wireless connectivity and wiring in the headset speakers may cause noise interference. Many manufacturers of headsets and headset systems have developed noise reduction audio speakers. Advanced noise reduction technology is an essential requirement for the M-Piece communication system methodology requirements for eliminating or significantly minimizing noise interference with multiple headset communications.

Communications between multiple headsets and headset systems requires wireless technology. Wireless or Wi-Fi technology uses radio waves to transmit and receive data. It is the technology that allows one device to communicate to another device without a physical connection. Other than communications on a headset, some example include cell phones, remote controls, wireless routers, keyless entry systems for cars or controllers to electronic game consoles.

As mentioned above, headsets are used for multiple communications during the course of a sports event such as a football game and other events/activities. Effectively communicating on headsets and headset systems require that there are no interruptions due the failure of a wireless connectivity. If the connection is interrupted by either dropping the connection, static, and/or sporadic coverage, the communication from the headset will be ineffective.

Another essential requirement for communicating on a headset is the protection of privacy. The protection of confidential communications from interception, misdirection, or theft is essential for effective headset communications. For example, there are many instances where audio communications may be intercepted by simply reading the lips of the communicating party.

For years, whether on a cell phone or landline, individuals have been concerned about the protection of privacy in their communications. Although the reasonable expectation of privacy is a concern and expectancy, there are no absolute protections that exists in the use of a headset or headset systems. In instances where a coach uses a headset in a game environment or a cell phone, or another device, requiring a headset for its use, his/her communication might be intercepted by an opposing coach(es) or another individual. The interception may occur by reading the lips, monitoring, or overhearing the communication of the communicating party.

To avoid providing third party access to the communication or intercepting what is being said, the communicating party, often times, holds his/her hand or object to shield his/her mouth in plain view. In addition to hand shielding, some objects used to shield the front of the mouth of the communicating party to protect from lip reading includes clip boards, playbooks, pieces of paper, cardboard; etc.

There are a variety of situations and scenarios involving the protection of privacy while speaking into a headset with a microphone has, unintentionally, exposed private or confidential information. For example, the NFL investigated an incident where one team alleged that the other team intercepted and stole their plays during a game. The intercepted team alleged that the intercepting team gained an advantage during the game and future games because of the confidential information on the plays. In instances where the communicating party fails to or forgets to shield his/her mouth or accidently lowers a shielding object during communication, a third party, spy, or opposing coach can acquire valuable information including trade secrets.

In addition to the utilization of a headset for communication in sporting events, there are other events/activities that require other utilizations of a headset. These instances/events include logistical activities such as moving products, bulk packages, the movement of people, or transportation; etc. Communicating logistical information/data is required to coordinate the storage and delivery manufacturing of storage; transportation; warehousing; concerts and entertainment; parking; people movement; and other activities in industries requiring logistics.

Headset systems for communicating between multiple parties are often utilized in the coordination of logistics activities. For example, in manufacturing, delivery and storage facilities, there are daily activities that require the use of a headset. These activities include communications regarding the movement of heavy loads of machinery, products and materials, for storage, warehousing, and delivery.

Another scenario involving headset communications for logistics purposes is in the concert and entertainment industry. In some instances, it may involve coordinating the seating for large crowds in an arena or concert hall. In other situations, it may involve coordinating the orderly parking of cars for a large concert or entertainment event. Multiple headphones are utilized to communicate between multiple individuals with the responsibility for coordinating these activities.

Headphones are used for coordinating logistics in the transportation industry. Examples include the use of headsets to coordinate parking, dispatching, and delivery of fleets of commercial transfer trucks and rental cars. Also, multiple headsets are used for coordinating vehicles, airplanes, boats, cruise ships in transportation centers such as in garages, airports, and docks.

Headphones with audio capabilities are utilized in critical situations involving first responders, catastrophic events, and medical emergencies. Examples include (a) automobile accidents, house fires; (b) heart attacks, seizures, surgeries; etc.; (c) floods, tornados, hurricanes; and many other emergency events. When these events occur, first responders including emergency personnel, medical professionals, firemen, etc. utilize headsets to communicate between multiple emergency professionals and facilities; i.e. hospitals, police departments; etc. Technological advances have expanded the capabilities of devices beyond the audio capabilities for communications. Cell phone manufacturers have developed smartphones which have expanded the applications to digital cameras for taking still photographs with high resolution. In addition to the advancement of photographic technology, smartphones provide video recording capabilities. Both of these technologies provide the availability for capturing real time pictures and videos of the activity or event.

### SUMMARY OF THE INVENTION AND ADVANTAGES

The present invention comprises an encased LED/LCD flat screen monitor with a camera, video/camcorder, microphone, and digital text display. In one aspect, the light emitting diode (LED/LCD) is a two-lead semiconductor light source. It is a p-n junction diode that emits light when activated. When a suitable current is applied, the lead electrons are able to recombine with electron holes with the device, releasing energy in the form of photons.

In one aspect, the LED/LCD will have many advantages over incandescent light sources, including lower energy consumption, longer lifetime, improved physical robustness, smaller size, and faster switching.

In one aspect, the monitor and attached visor will cover the face of the communicating party which will shield or block the mouth of the communicating party.

In one aspect, the LED/LCD flat screen monitor will be attached to a black bar frame made of plastic coated metal or 3D printed hard plastic which is attached to a metal bracket with screws for attachment and movability of the monitor or panel on the headset.

In one aspect, the LED/LCD monitor provides a shield and/or a block of the mouth that will protect the privacy of the communicating party's audio communications. This will prevent spying and communication intercepting by third parties.

In one aspect, the digital display system on the monitor will allow for wording, texts, logos, signs, signals, information for advertising, symbols, numbers; etc. The advantages of the digital display are (a) allows for textual communications; (b) provides a logo identifier for branding purposes; (c) textual information for advertisements; and (d) allows for numeric information.

In one particular aspect, the encased monitor will contain one or more built-in digital cameras and camcorder which is able to capture photographs and record videos. The advantage of digital camera and camcorder embedded in the monitor will make it simpler than a stand-alone digital camera. Other advantages include cost and compactness. Photoflash will be provided by an LED/LCD source which illuminates less intensely over a much longer exposure time than a bright and near-instantaneous flash strobe. The cameras will have the capability of connecting to Wi-Fi and can make geotagged photographs.

### BRIEF DESCRIPTION OF THE SEVERAL VIEWS OF THE DRAWINGS

A more particular description of embodiments of the invention briefly summarized herein may be had by references to the embodiments which are shown in the drawings which form a part of this specification. These drawings illustrate the preferred embodiments at the time of the filing of this patent and are not to be used to improperly limit the scope of the invention which may have other equally effective or legally equivalent embodiments.

FIG. 1 illustrates the front elevation view of the system according to the present invention.

FIG. 2 illustrates the top view of the system according to the present invention.

FIG. 3 illustrates the right-side elevation view of the system according to the present invention.

FIG. 4 illustrates the left-side elevation view of the system according to the present invention.

### DETAILED DESCRIPTION OF THE INVENTION

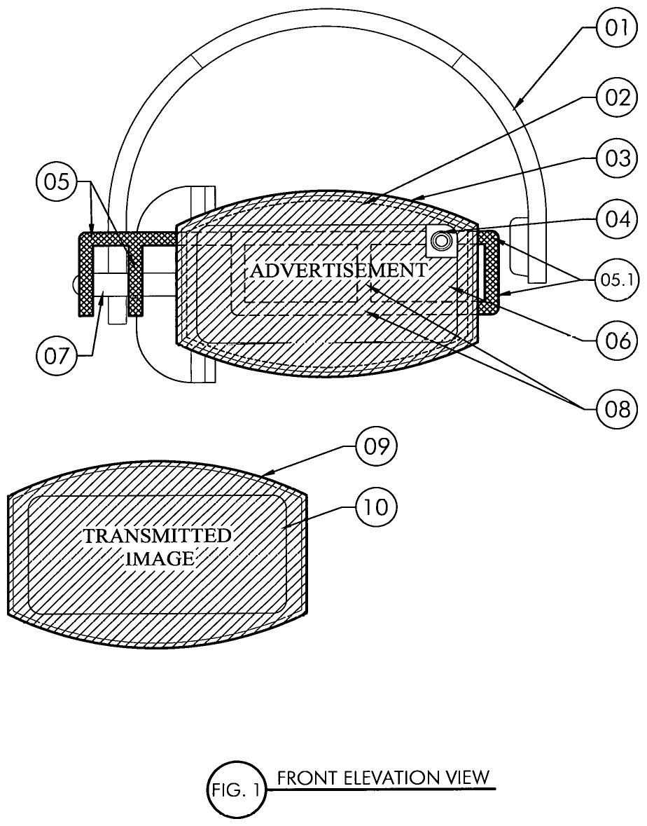

FIG. 1 refers to the view of a commercially manufactured headset (01) (hereafter referred to as headset) in the global market and the present invention; the M-Piece Headset Communication Enhancement System (hereafter referred to as M-Piece system) displayed in (02). The M-Piece system (02) is a flat screen monitor that is attachable to a user's headset for audio communications, digital display, and privacy protection. Essential requirements for using a headset (01) are met by utilizing the M-Piece system (02) while communicating between a user of another headset user such as (a) noise reduction; (b) Wi-Fi or wireless connectivity; or (3) privacy protection. The M-Piece system (02) provides several options and advantages that the headset (01) alone does not provide a user such as a flat screen monitor that displays textual messages and images; a high-quality fiber optics microphone (07.1) for voice communication to other users utilizing the headset system; a camera/camcorder (04) that enables a user to take photographs and videos of activities such as sporting events, emergency conditions, and logistical images; and privacy protection for shielding the mouth from an onlooker while communicating. The M-Piece system (02) is encased or surrounded by a protective plastic or metal covering (03) that protects it from accidental damage, wear and tear. Shown in FIG. 1 is a second digital display screen (06) that appears on the front side of the M-Piece system (02) that may be viewed by an onlooker. The digital display screen (06) is designed to provide several benefits such as displaying textual information, signs, logos, advertisements; etc. FIG. 1 shows a quarter inch (V) diameter metal bar frame (05) that supports the M-Piece system (02) when attached to the headset (01). It is attachable to the headset (01) and provides flexible utilization by a user of the M-Piece system (02) and allows for an upward/downward motion or an extended length of the bar for easily viewing the M-Piece system (02). FIG. 1 shows a wristband control monitor (10) that is designed to show the identical information displayed to a user on the M-Piece system (02). The purpose of the wristband control monitor (10) is to provide a user with a mobile option for viewing the textual messages and images displayed on the M-Piece system (02). The wristband control monitor (10) is protected by a protective case around the perimeter of the wristband control monitor (09).

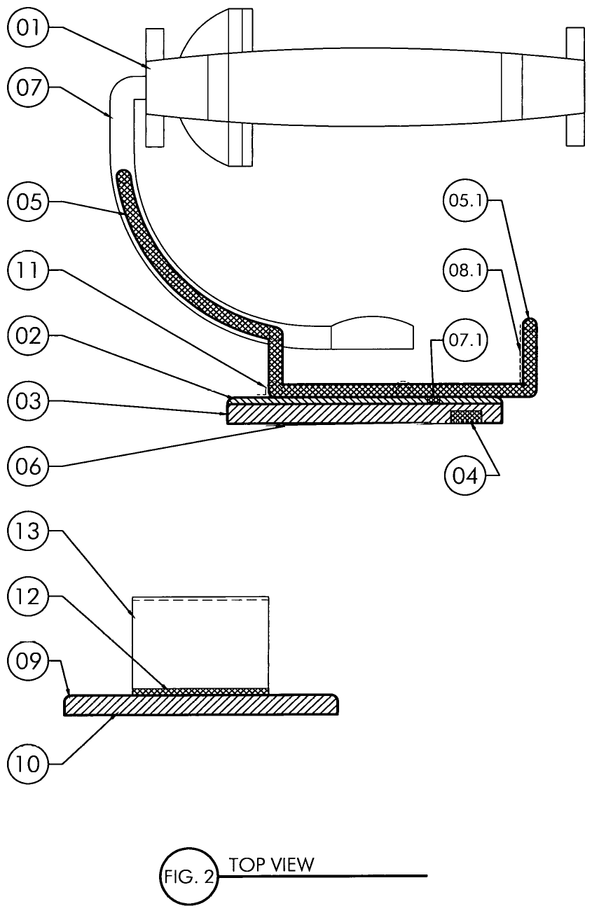

FIG. 2 shows the top view of a commercially manufactured headset (01) and the M-Piece system (02) invention. The headset (01) arm (07) is attached to the headset (01) and the M-Piece system (02). In this view the headset arm (07) is supported by a one quarter inch (¼″) diameter bar frame (05) which extends (05.1) across the M-Piece system (02) to securely support the system. An addition to the diameter bar frame (05) a polycarbonate visor (08.1) is attached to the M-Piece system (02) which is designed to provide additional support while attached to the headset (01), as well as, ensures privacy protection by shielding the mouth of an M-Piece (02) user. The FIG. 2 view shows the protective case (03) that surrounds the perimeter of the digital display screen. FIG. 2, also, shows the digital display screen (06) and the placing of the metal bracket and screws (11) that support the M-Piece system (11) as it attaches to the headset (01).

FIG. 2 displays the wristband (12), wristband frame (13), the protective case (09) and the (10) and the wristband control monitor. The wristband (12) is operational like a mobile device and provides a user with the option of viewing the textual messages, photographic and videos images that are viewable on the M-Piece system (02).

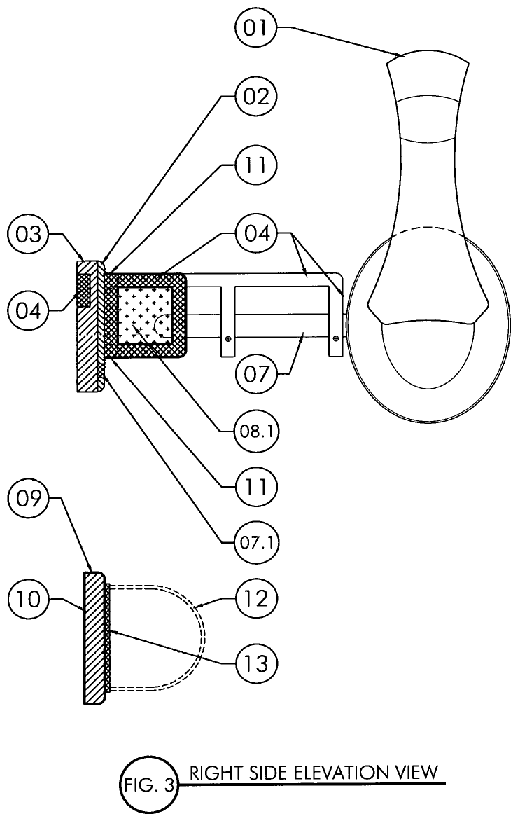

The FIG. 3 view of the invention displays the commercially manufactured headset (01) and the M-Piece system (02) invention. The headset (01) arm (07) is attached to the headset (01) and the M-Piece system (02) and the protective case (03) that encases the M-Piece system (02). Viewed in FIG. 3 is a camera/camcorder (04) that enables a user to take photographs and videos of activities such as sporting events, emergency conditions, and logistical images. (07.1) shows the voice communication unit of the M-Piece system (02), a polycarbonate visor (08.1) which is attached to the M-Piece system (02) which is designed to provide additional support while attached to the headset (01) ensuring privacy protection by shielding the mouth and metal bracket and screws (11) that support the M-Piece system (11) as it attaches to the headset (01).

FIG. 3 displays the wristband (12), wristband frame (13), the protective case (09) and the (10) and the wristband control monitor. The wristband (12) is operational like a mobile device and provides a user with the option of viewing the textual messages, photographic and videos images that are viewable on the M-Piece system (02).

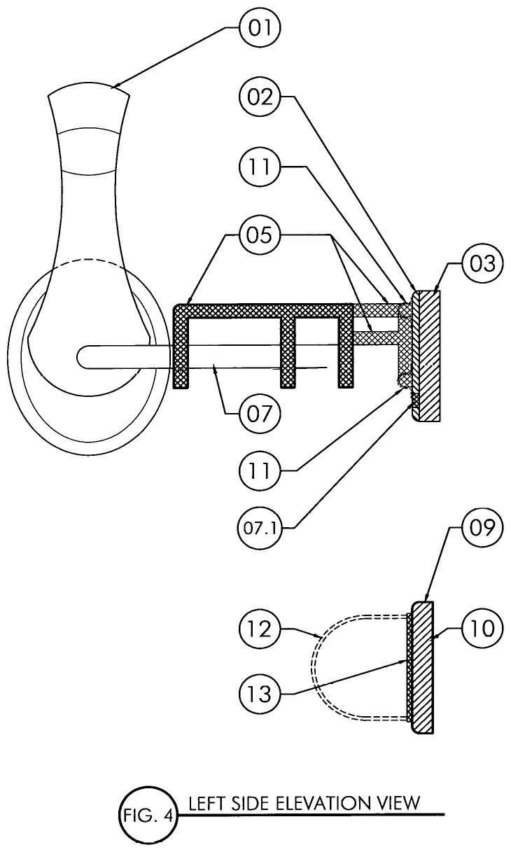

The FIG. 4 view of the other side of the invention displays the commercially manufactured headset (01) and the M-Piece system (02) invention. The headset (01) arm (07) is attached to the headset (01) and the M-Piece system (02) and the protective case (03) that encases the M-Piece system (02). Viewed in FIG. 3 is a camera/camcorder (04) that enables a user to take photographs and videos of activities such as sporting events, emergency conditions, and logistical images. (07.1) shows the voice communication unit of the M-Piece system (02), a polycarbonate visor (08.1) which is attached to the M-Piece system (02) which is designed to provide additional support while attached to the headset (01) ensuring privacy protection by shielding the mouth and metal bracket and screws (11) that support the M-Piece system (11) as it attaches to the headset (01).

FIG. 4 displays the wristband (12), wristband frame (13), the protective case (09) and the (10) and the wristband control monitor. The wristband (12) is operational like a mobile device and provides a user with the option of viewing the textual messages, photographic and videos images that are viewable on the M-Piece system (02).

M-Piece Headset Communication Enhancement System is an invention designed to enhance a commercially manufactured headset available in the marketplace. In referring to commercially manufactured headsets, as in FIG. 0.4 and incorporated fully herein for all purposes, there is a microphone and speaker system. These must meet the requirements necessary for effective audio communications between headsets. Those communication requirements include (a) noise reduction; (b) Wi-Fi or wireless connectivity; or (c) privacy protection.

Privacy is essential for communicating on a headset in many events, activities, and industries. One such industry, the sports industry, specifically football, is an example where these requirements are essential. The utilization of commercially manufactured headsets and headset systems are utilized for communication between coaches and players. During the course of a football game or practice, coaches utilize headsets to communicate with other coaches positioned throughout a stadium or practice field. The coaches communicate game plays, strategies, and other instructions. In these instances, although the commercially manufactured headsets meet most requirements, an essential requirement that is not met is that of the protection of the confidential communications between the parties from potential interference and interception. For example, the microphone bar, on a commercially manufactured headset, is thinly constructed and does not cover or shield the mouth very well. Coaches have attempted several methods for protecting their confidential communications by shielding their lips with clip boards, cardboard, players and coaches standing in front of them, and their hands. The M-Piece Headset Communications Enhancement System invention provides the option to protect confidential information by shielding the mouth of a communicating party.

Commercially manufactured headsets have other technical limitations. For example, other technology is often required such as cameras and camcorders for still photographs and video recording is a technical enhancement that would bring value to the use of headsets. This technology would provide the communicating party with technology functions that they currently need but have to be accomplished by the use of the technology independently from the headset. Camera and camcorder are available with the M-Piece Headset Communications System.

FIG. 01 shows the ¼ metal or plastic diameter bar frame that attaches the M-Piece communication system to the headset. The bar frame is designed to be extended for flexible viewing of the flat screen monitor by the communicating party. The bar frame is, also, designed to detach from the headset which will allow the communicating party the ability to view the M-Piece flat screen monitor to view verbiage, images, photographs, and video recordings. The wristband control monitor in FIG. 8 provides the option of viewing the information transmitted from the encased flat screen monitor.

The M-Piece communication system consists of two flat screen monitors shown in FIG. 01.1 and FIG. 0.3. The monitor may be LED/LCD or the latest technology. The flat-screen displays are electronic viewing technologies used to enable people to see content such as the still photographic images, moving images, text, or other visual material and provides the highest resolution view. The technology is lightweight and thinner than the tradition cathode ray tubes monitors and video displays and are less than 10 centimeters.

On FIG. 01.1, the primary flat screen LED/LCD monitor side, visible to the communicating party, text, diagrams, logos, signals, photographs, and video recordings are viewable. FIG. 3.0 provides the monitor viewable to the non-communicating party(s). The monitor may display text, images, logos, advertisements, and other verbiage or images. One of the primary advantages of the flat screen monitor is utilizing the monitor to shield and/or block the mouth from the view of any onlookers. In addition to the metal or plastic diameter bar frame shown in FIG. 0.1, as shown in FIG. 0.2, there is a plastic or metal covering designed to encase and protect the LCD/LED flat screen monitor.

FIG. 04 is a commercially manufactured headset available to consumers in the marketplace that utilizes headsets in a variety of industries. The M-Piece Communication System is an enhancement to any headset and headset system as an attachment to the headset. The system is attached by a ¼ diameter bar frame that supports it on the headset. The system, as attached to the headset, provides significant protection for confidential communications by shielding the mouth from onlookers during the communication process. As in FIG. 05, a polycarbonate visor is an extension to the bar frame and supports the encased flat screen monitor. Also, as shown in FIG. 06, black metal bracket and screws connect the flat screen monitor to the metal frame.

FIG. 07—The camera and camcorder installed, as part of the M-Piece Communication System, provides the communication party with the ability to take photographic images and video recordings. As part of the system, these are distinct enhancements to a headset by providing the communicating party with the access to high definition technology. For example, in situations involving a medical or catastrophic event, the communicating party or first responders, utilizing the system and headset may take still photographs and video recordings that may be submitted to hospital emergency rooms, fire departments, medical and safety professionals.

FIG. 07.1—in addition to the camera and camcorder, the communication system's flat screen monitor includes a microphone for audio communication. The microphone allows the communicating party with the option of communicating with multiple communicating parties with headsets.

An advantage to the M-Piece Communication System is providing the communicating party with the ability to view images and other data on the LED/LCD flat screen monitor. The communicating party may view on the monitor while it is mounted on his/her head or he/she may detach the monitor from the headset and view the monitor.

On the other hand, if the communicating party prefers not to detach the monitor, another viewing option shown in FIG. 08, is by utilizing a Wristband Control Monitor. The control monitor makes it possible for the communicating party to view the texts, diagrams, photographic images, and video recordings transmitted from the monitor, camera, and/or camcorder from the M-Piece Communication System. The control monitor is attached to an elastic wristband, as in FIG. 10, and attachable to the communicating party's′ wrist. To protect the wristband control monitor from damage to the monitor, FIG. 09 provides a plastic or metal protective frame that encases the control monitor.

### LEGEND OF PARTS

01 commercially manufactured headset
02 flat screen monitor
03 protective case around the perimeter of digital display screen
05 high definition camera
05 ¼″ diameter bar
06 digital display screen
07 commercially manufactured headset arm
07.1 voice communications
08 bar frame beyond
09 protective case around the perimeter of wristband control monitor
10 detachable wristband control monitor
11 black metal bracket and screws
12 wristband
13 wristband frame

What is claimed is:

1. A communication system that provides enhancements to a commercially manufactured headset or headset system comprising:
a first flat screen monitor, wherein the monitor provides a user with usability during all-weather conditions and shielding of the mouth for confidential communications by a user, and visual display of textual messages and images while the monitor shields the mouth of the user for confidential communications;
a high fiber optics microphone for audio communications to another user of the headset system;
a SIM (subscriber identity module or subscriber identification module) for connecting to mobile internet services;
a camera/camcorder for taking still photographs, images, and video recordings;
Wi-Fi or wireless communications for transmitting and receiving information;
a second flat screen monitor with digital display, wherein the monitor flat screen monitor provides a user with the display of images, logos, signs, textual messages, advertisements;
a protective plastic or metal bar frame for protecting the first flat screen monitor and second flat screen monitor;

2. The communication system of claim 1 further comprising a support structure for attaching the communication system to the headset comprising
an adjustable and extendable diameter bar frame with brackets designed to support the attachment of the system to the headset;
a polycarbonate visor wherein the majority of the flat screen monitor is fully encased;
metal brackets and screws for supporting the flat screen monitor attachable to and detachable from a headset.

3. The communication system of claim 1 further comprising of a wristband with a wristband control monitor that provides accessibility for viewing photographic images, video recordings, text, data, verbiage, and diagrams transmitted from communication system further comprising
an elastic wristband for attaching the control monitor to the wrist of the communicating party;
a LED/LCD or another high-quality monitor for viewing the transmitted photographic images, video recordings, text, data, verbiage, and diagrams;
a protective frame that protects the flat screen control monitor.
